(19) United States
(12) Patent Application Publication
(10) Pub. No.: US 2026/0091719 A1
(43) Pub. Date: Apr. 2, 2026

(54) Pro-Tech Your Sole

(71) Applicant: Ameer B Tillman, Conyers, GA (US)

(72) Inventor: Ameer B Tillman, Conyers, GA (US)

(21) Appl. No.: 19/250,075

(22) Filed: Jun. 26, 2025

Related U.S. Application Data
(60) Provisional application No. 63/639,764, filed on Apr. 29, 2024.

(51) Int. Cl. B60N 3/04

(52) U.S. Cl. CPC B60N 3/04

(57) ABSTRACT

The product is designed to protect the heel of your right shoe from being soiled or damaged by your automobile floors/rug/mat during driving. The product consists of four materials to protect the heel outer sole of your shoes. The bottom layer is a gripping rubber spiked bottom to keep the product in position when in use. The following layers are a shock absorbing EVA foam relieving pressure on the heel of your shoe. There is a rubber layer preventing the heel from being damaged or soiled. The top layer consists of a non-marking, stain resistant silicone sheet protecting the heel of your shoes.

### PROBLEM

The heel of footwear gets soiled and damaged by vehicle surfaces while driving. The product will protect the surface of the shoe from damages and stains. Current car mats do not protect the sole of your shoe.

### SUMMARY

The product is a pad meant to lay on your car's mat/rug/floor that is designed to protect the heel of your right shoe from being soiled or damaged by your automobile mat/rug/floor during driving. The product consists of shock absorbing, non-marking materials with a gripping bottom layer that prevents movement while in use.

### BRIEF DESCRIPTION OF THE DRAWINGS

FIG. 1 Silicone

FIG. 2 Industrial Rubber

FIG. 3 EVA Foam

FIG. 4 Rubber

FIG. 5 Rubber Spiked Teeth

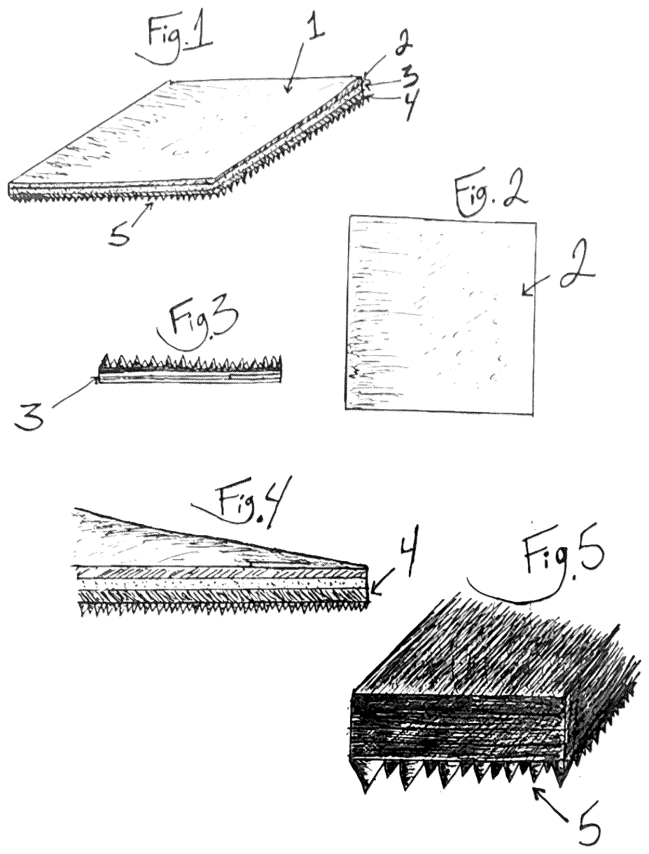

### DETAILED DESCRIPTION OF THE INVENTION

The heel pad, 7×7×2.5, comprising five layers, is held together by three bonding methods. The thermo-bonding holds together the top silicone layer with the rubber layer. The industrial glue will bond together the bottom layer with the foam layer. The stitching will bond the five materials together. The base layer is designed to rest flat on a vehicle's floor surface holding it in place with the rubber grippers. The following layer consist of a rubber layer. The next layer consists of a shock absorbing, high density EVA foam relieving pressure on the heel of your shoe. The following layer is a non-marking rubber that will provide additional padding. The top layer consists of a stain resistant, non-slip silicone sheet protecting the heel of your shoes. The shape of the heel pad is contoured to sit under the heel of the driver's shoe without movement.

1. The product provides protection for the heel of the right shoe by preventing the transfer of contaminants and reducing damage resulting from contact with vehicle surfaces during driving.
